(19) United States
(12) Patent Application Publication
(10) Pub. No.: US 2026/0101367 A1
(43) Pub. Date: Apr. 9, 2026

(54) UPDATE PROCEDURES FOR CO-EXISTENCE HANDLING IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/348,017

(22) Filed: Oct. 2, 2025

Related U.S. Application Data
(60) Provisional application No. 63/705,350, filed on Oct. 9, 2024.
(60) Provisional application No. 63/728,035, filed on Dec. 4, 2024.
(60) Provisional application No. 63/761,694, filed on Feb. 21, 2025.

(51) Int. Cl. H04W 74/04; H04W 84/12

(52) U.S. Cl. CPC H04W 74/04; H04W 84/12

(57) ABSTRACT

A station (STA) includes a processor configured to determine scheduling information for one or more unavailability events. The STA also includes a transceiver operably coupled to the processor. The transceiver is configured to transmit, to an access point (AP), a control frame including the scheduling information for the one or more unavailability events.

### CROSS-REFERENCE TO RELATED APPLICATION(S) AND CLAIM OF PRIORITY

This application claims priority under 35 U.S.C. § 119 (e) to U.S. Provisional Patent Application No. 63/705,350 filed on Oct. 9, 2024, U.S. Provisional Patent Application No. 63/728,035 filed on Dec. 4, 2024, and U.S. Provisional Patent Application No. 63/761,694 filed on Feb. 21, 2025. The above-identified provisional patent applications are hereby incorporated by reference in their entirety.

### TECHNICAL FIELD

This disclosure relates generally to wireless networks. More specifically, this disclosure relates to update procedures for co-existence (Co-Ex) handling in wireless local area networks (WLANs) including next generation WLANs.

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for update procedures for Co-Ex handling in WLANs.

In one embodiment, a station (STA) is provided. The STA includes a processor configured to determine scheduling information for one or more unavailability events. The STA also includes a transceiver operably coupled to the processor. The transceiver is configured to transmit, to an access point (AP), a control frame including the scheduling information for the one or more unavailability events.

In another embodiment, an AP is provided. The AP includes a transceiver configured to receive, from a STA, a control frame including scheduling information for one or more unavailability events. The AP also includes a processor operably coupled to the transceiver. The processor is configured to determine an unavailability time of the STA based on the scheduling information, and refrain from scheduling a downlink transmission for the STA during the unavailability time.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The following documents and standards descriptions are hereby incorporated into the present disclosure as if fully set forth herein: [1] IEEE P802.11be/D3.0, 2023; and [2] IEEE Std 802.11-2020.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example UWB ranging round according to embodiments of the present disclosure;

FIG. 4 illustrates an example Zigbee timeline according to embodiments of the present disclosure;

FIG. 5 illustrates an example method for handover according to embodiments of the present disclosure;

FIG. 6 illustrates an example of a second Co-Ex event occurrence according to embodiments of the present disclosure;

FIG. 7 illustrates an example of an uplink pause according to embodiments of the present disclosure;

FIG. 8 illustrates an example of updating Co-Ex/unavailability information at an AP through a modified BA variant according to embodiments of the present disclosure;

FIG. 9 illustrates an example of sending an unsolicited ICR according to embodiments of the present disclosure;

FIG. 10 illustrates an example of Co-Ex/unavailability cancelation according to embodiments of the present disclosure;

FIG. 11 illustrates an example of Co-Ex/unavailability update according to embodiments of the present disclosure;

FIG. 12 illustrates an example of invoking a prioritized EDCA to flush out uplink packets prior to roam according to embodiments of the present disclosure;

FIG. 13 illustrates an example of invoking a prioritized EDCA to flush out uplink packets upon roam according to embodiments of the present disclosure;

FIG. 14 illustrates an example method for unavailability event handling according to embodiments of the present disclosure; and

FIG. 15 illustrates another example method for unavailability event handling according to embodiments of the present disclosure.

### DETAILED DESCRIPTION

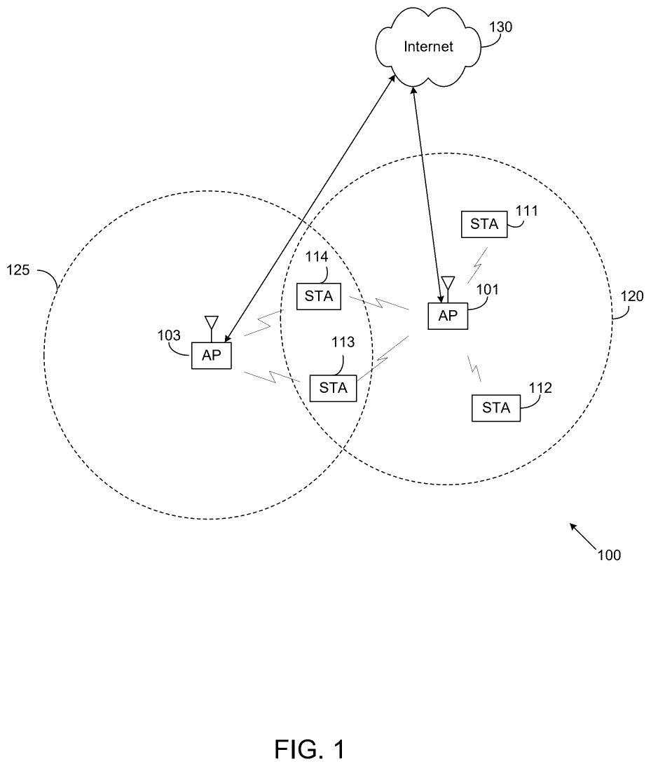

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

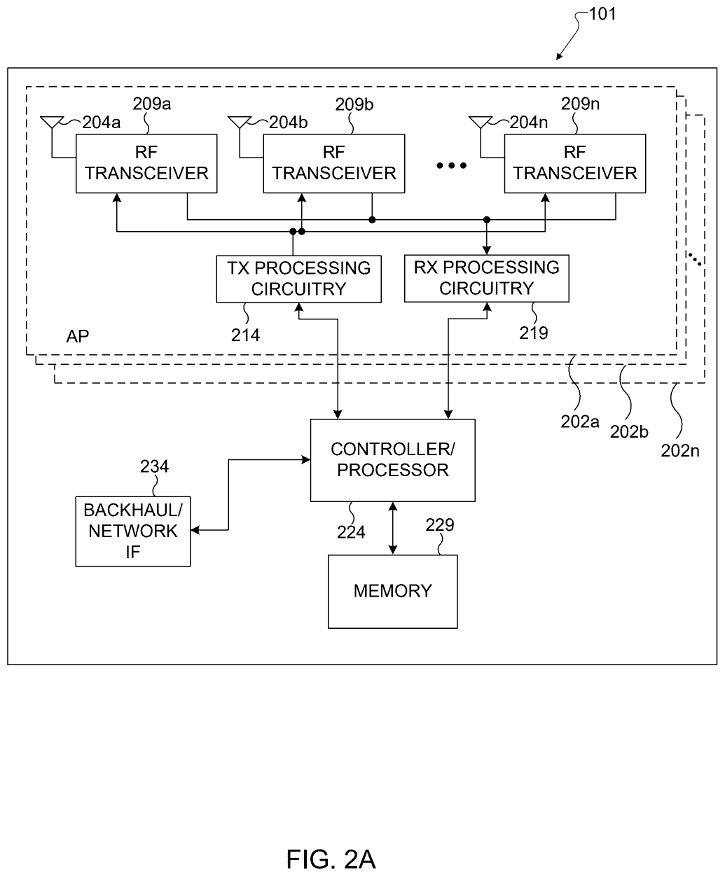

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHZ, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Wi-Fi devices may include a number of Wi-Fi and non-Wi-Fi radios that can co-exist on the same device. Examples of non-Wi-Fi technology radios which can co-exist with Wi-Fi include, but are not limited to Bluetooth, Ultra-Wide Band (UWB), Zigbee.

Bluetooth is a wireless technology that started off as a short-distance cable replacement mechanism. Bluetooth classic, which is used for streaming applications (e.g., headsets) operates on 79 RF channels each spaced 1 MHz apart. Bluetooth low energy (BLE), which is used for IoT applications, operates on 40 RF channels each spaced 2 MHz apart. In the case of Bluetooth, some channels are reserved specifically for the purpose of advertisement and others are used for secondary advertisement for data transmission. In the case of Bluetooth classic, 32 channels are reserved for advertisement whereas in the case of BLE, 3 channels are reserved for advertisement.

In Bluetooth devices, transmission happens as a part of a connection event. During a connection event, two devices that are engaged in data transmission alternate sending data until the data to be sent on both sides is exhausted. One of the devices acts as the master and the other device acts as the slave. The master sends a packet to the slave and if the slave receives the packet it sends back a packet to the master. The duration between two connection events is called a connection interval. Connection interval values can go from 7.5 ms to 4 s. The exact value can be negotiated between the master and the slave to optimize their power saving while balancing latency incurred. Bluetooth transmissions follow a frequency hopping spread spectrum method where a hopping sequence is used to rapidly hop between data channels.

As Bluetooth and Wi-Fi follow different channel access protocols, coexistence (Co-Ex) of Bluetooth can lead to interference with Wi-Fi transmissions. Some Bluetooth transmissions can be scheduled making the interference more predictable. However, in other cases, Bluetooth interference can be hard to predict in advance. Thus, Wi-Fi would benefit from mechanisms to react to Bluetooth interference when Bluetooth interference occurs in such cases.

Today Bluetooth is used for a large number of applications such as streaming applications, sensor applications, way finding based on beaconing, etc. Wi-Fi routers from a few vendors also come equipped with Bluetooth radios for the purpose of way finding/location awareness applications. Further, an end user's phone can also be configured as a Mobile AP which can also have Bluetooth operating on it.

Bluetooth has primarily operated on the 2.4 GHz band. However, in next generation Bluetooth technology, the operation is expected to be extended to the 5 GHz and 6 GHz bands as well. Thus, the interference problem can be worse for Wi-Fi operation which also uses these bands for communication.

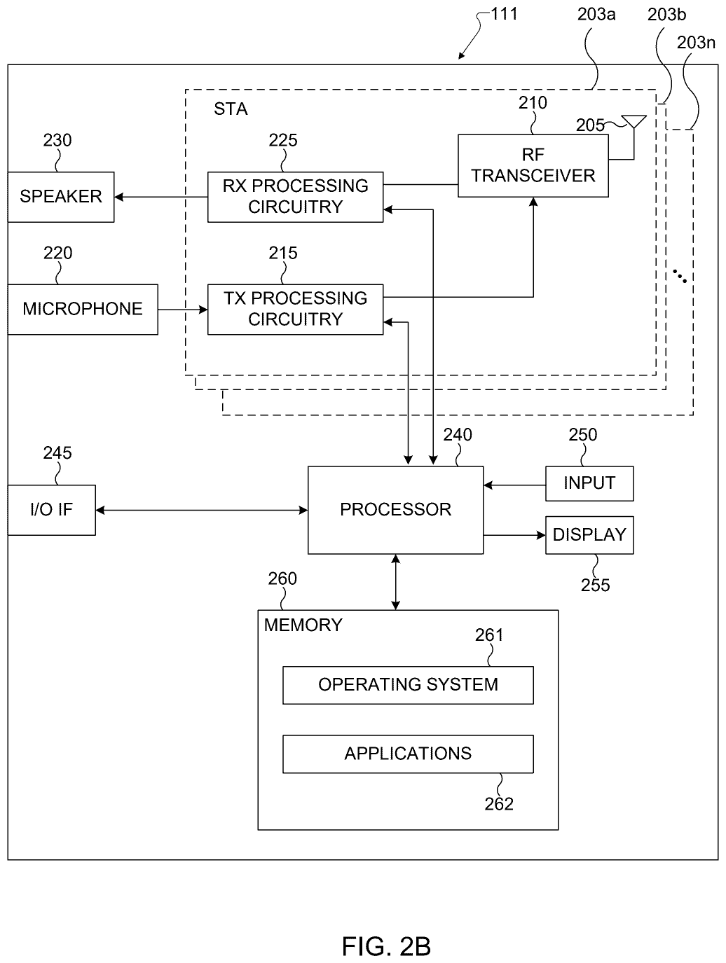

Ultra-Wide Band (UWB) has recently become popular for use cases involving indoor positioning and navigation using the 6 GHz band. UWB currently supports a block based mode for ranging in which there are ranging blocks which are divided into ranging rounds which are further divided into ranging slots. The number of ranging rounds in a ranging block, the number of ranging slots in a ranging round and the duration of ranging slot are transmitted by the controller in a ranging control message (RCM) to the participant devices. The information can be for a current ranging round and potential subsequent ranging rounds as well. A ranging slot in which the device is expected to be active is referred to as an active slot. There can also be inactive and silent periods. An example ranging round is as shown in FIG. 3.

FIG. 3 illustrates an example UWB ranging round 300 according to embodiments of the present disclosure. The embodiment of a ranging round of FIG. 3 is for illustration only. Different embodiments of a ranging round could be used without departing from the scope of this disclosure.

In the example of FIG. 3, the ranging round 300 includes active slots and inactive/silent slots. The active slots are shown as shaded, while the inactive/silent slots are shown in white.

Although FIG. 3 illustrates one example UWB ranging round 300, various changes may be made to FIG. 3. For example, various changes to the number of active and inactive slots could be made, etc. according to particular needs.

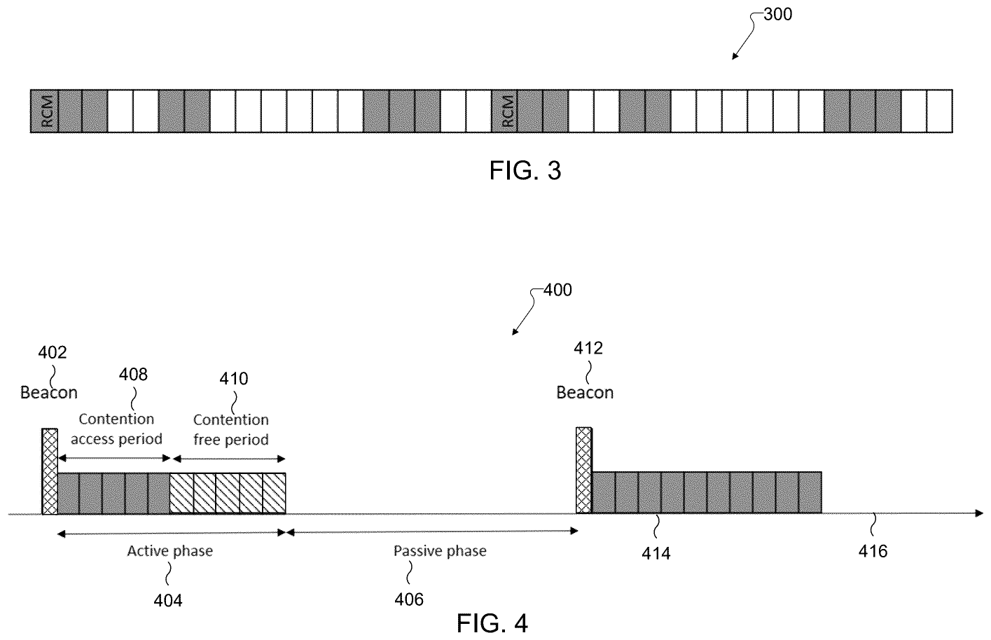

The ZigBee protocol is another technology developed for smart home applications. The protocol operates based on the concept of beacon intervals. A coordinator in a ZigBee operation sends out periodic beacons. Each beacon is followed by the start of an active phase. The beacon announces the duration of the active phase and the time until the next beacon transmission. Each beacon interval thus is divided into two phases—an active phase which starts right after the beacon transmission, and a passive phase for power saving. The active phase can be divided into contention based periods and contention free periods. The duration of each of the phases and the beacon interval can be characterized by the parameters aBaseSlotDuration value, macBeaconOrder (BO) and macSuperframeOrder (SO). BO and SO are integer values ranging from 0 to 14. The beacon interval can be computed as aBaseSuperframeDuration*2^{BO} and the active phase can be computed as aBaseSuperframeDuration*2^{SO} where aBaseSuperframeDuration=16*aBaseSlotDuration. An example Zigbee timeline is as shown in FIG. 4.

FIG. 4 illustrates an example Zigbee timeline 400 according to embodiments of the present disclosure. The embodiment of a Zigbee timeline 400 of FIG. 4 is for illustration only. Different embodiments of a Zigbee timeline could be used without departing from the scope of this disclosure.

In the example of FIG. 4, the Zigbee timeline 400 includes a beacon interval, which is the time between the start of beacon 402 and the start of beacon 412. Beacon 402 includes an active phase 404 and a passive phase 406. The active phase includes a contention based access period 408 and a contention free period 410. Beacon 412 includes an active phase 414, which is entirely a contention based access period, and a passive phase 416.

Although FIG. 4 illustrates one example Zigbee timeline 400, various changes may be made to FIG. 4. For example, various changes to the beacon interval could be made, various changes to the phase lengths could be made, etc. according to particular needs.

Wi-Fi networks currently support a wideband channel usage where channels are divided into primary and secondary channels. Under existing Wi-Fi procedures, for transmission to occur on a wideband, the primary channel must be idle. If the primary channels are busy, the secondary channels cannot be accessed.

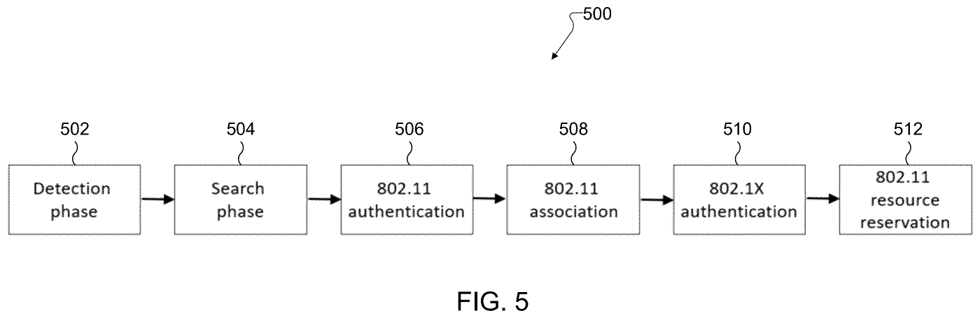

As users move around, the signal strength of a STA to its connected AP can vary. If user movement causes a significant decrease in the signal strength, a handover may be beneficial. During the process of handover, the STA switches from its current associated AP to a new AP. For devices that lack mobility support, handover may use the procedure shown in FIG. 5.

FIG. 5 illustrates an example method for handover 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for handover could be used without departing from the scope of this disclosure.

In the example of FIG. 5. The method for handover 500 begins at step 502, which is a detection phase. During the detection phase, the STA determines that a handover is triggered. The procedure to detect that a handover is triggered is up to vendor implementation. For example, a particular vendor implementation can choose to trigger handover when the signal strength to the currently associated AP drops below a certain threshold.

After the STA determines that a handover is triggered, the method proceeds to a search phase at step 504. During the search phase, the STA searches for new APs to associate with. For example, in some embodiments, the STA performs a scan of different channels to identify APs in the vicinity. The search can be performed passively (e.g., listening to beacons on a particular channel) or actively (e.g., by the use of probe request and response procedure). During passive scanning, the scanning STA should wait on each channel for a sufficient amount of time to receive the beacon from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.

After the search phase, the STA performs 802.11 authentication (open system/shared key based) with a new AP at step 506. After the STA is authenticated, the STA performs 802.11 association at step 508.

After association, the STA performs 802.1X authentication at step 510. This phase includes an extensible authentication protocol (EAP) authentication between the STA and an authentication, authorization, and accounting (AAA) server with the assistance of the AP.

After 802.1X authentication, the STA sets up various resources at the new AP at step 512. For example, the STA can perform QoS reservation, BA setup, etc. with the newly associated AP.

Although FIG. 5 illustrates one example method for handover 500, various changes may be made to FIG. 5. For example, while shown as a series of steps, various steps in FIG. 5 could overlap, occur in parallel, occur in a different order, occur any number of times, be omitted, or replaced by other steps.

Typically, during a handover, there can be a service disruption in the connection as the setup procedure operates in a break-before-make manner. This can cause an impact on user experience, especially with multimedia services, which can suffer from session disruptions due to the high delay encountered during a handover procedure.

In order to reduce the handover delay, a number of procedures have been introduced, such as:
1 fast transition roaming which eliminates the need for the authentication step (step 506 in FIG. 5) during the handover;
assisted roaming which reduces the search phase (step 504 in FIG. 5) by allowing the STA to request the AP to send channel information of candidate neighbor APs;
network assisted roaming to assist the search phase;
fast basic service set (BSS) transition procedure, which helps to reduce the delays encountered due to 802.11 resource reservation (step 512 in FIG. 5).

The term logical AP MLD as used in the present disclosure may refer to any kind of coordination framework that enables a seamless roam for a STA (e.g., a seamless roaming domain, non-collocated AP MLD, enhanced FT design, etc.).

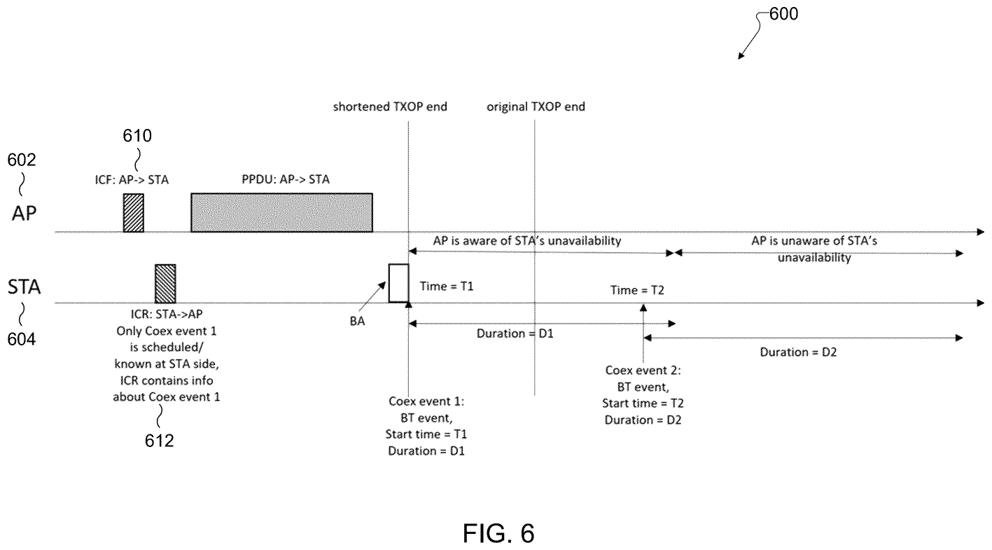

When a STA is operating under a Co-Ex constraint/mode, the STA's associated AP can transmit an initial control frame (ICF) at the beginning of a transmission opportunity (TXOP). The initial control response (ICR) from the STA transmitted in response to the ICF can contain information on an upcoming Co-Ex event. The information on the upcoming Co-Ex event may be referred to as scheduling information. This can enable the AP to shorten the AP's TXOP. However, during the indicated unavailability, another Co-Ex event can get scheduled at the STA. As this event's information was not available at the time of sending the ICR, the STA may not be able to report it to the AP. An example of this problem is shown in FIG. 6.

FIG. 6 illustrates an example of a second Co-Ex event occurrence 600 according to embodiments of the present disclosure. The embodiment of a second Co-Ex event occurrence of FIG. 6 is for illustration only. Different embodiments of a second Co-Ex event occurrence could be used without departing from the scope of this disclosure.

In the example of FIG. 6, an AP 602 sends an ICF 610 to a STA 604. At the time of receiving the ICF 610, STA 604 is aware of a Co-Ex event 1 and sends the information of Co-Ex event 1 to the AP 602 in the ICR 612. In response, AP 602 can shorten the TXOP length as per the indicated information to avoid Co-Ex event 1. However, before the end of the TXOP, another Co-Ex event 2 can get scheduled at a time T2 and with a duration of D2. However, STA 604 may not have an opportunity to indicate this duration to the AP 602. Thus, AP 602 may schedule STA 604 for a downlink transmission during duration D2. However, without the knowledge of STA 604's Co-Ex event (i.e., Co-Ex event 2), AP 604's actions may be inefficient (e.g., attempting transmission multiple times during duration D2 resulting in airtime wastage).

Although FIG. 6 illustrates one example of a second Co-Ex event occurrence 600, various changes may be made to FIG. 6. For example, various changes to times and durations could be made, etc. according to particular needs.

In some circumstances, a STA can also have a Co-Ex event scheduled and the STA's associated AP may not send an ICF to the STA. Thus, the STA may not get an opportunity to indicate its unavailability in an ICR.

Another problem can arise when the first Co-Ex event's parameters are changed. For example, if the first Co-Ex event increases or decreases in duration.

To address these problems, various embodiments of the present disclosure provide solutions for a STA to indicate its unavailability to an AP, as well as handling unavailability updates such as Co-Ex information updates.

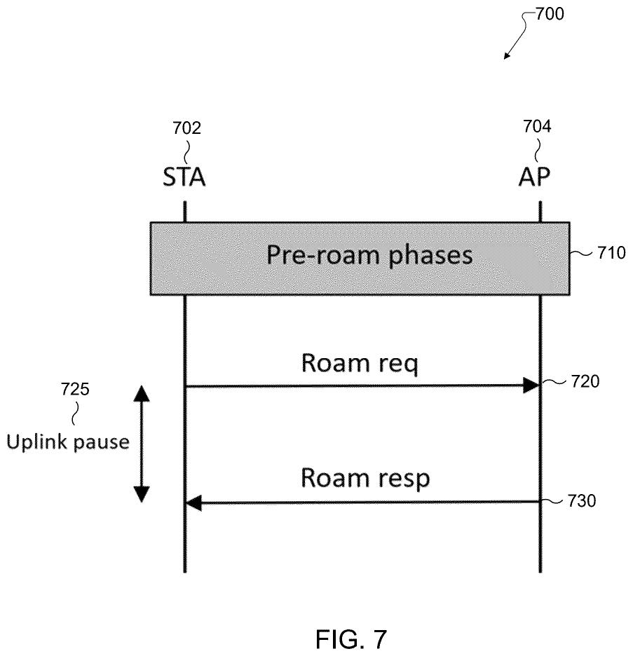

During a roaming procedure between a STA and its current AP, existing procedures do not permit the current AP to pass any user data in its received reordering buffer to the next MAC process after the distribution system (DS) mapping change has been notified as shown in FIG. 7. This can result in a pause for uplink transmission. This pause can cause problems for traffic of low latency applications due to packet drops due to expiration, longer delays, etc.

FIG. 7 illustrates an example of an uplink pause 700 according to embodiments of the present disclosure. The embodiment of an uplink pause of FIG. 7 is for illustration only. Different embodiments of an uplink pause could be used without departing from the scope of this disclosure.

In the example of FIG. 7, AP 704 is a current AP for STA 702 at step 710, where STA 702 and AP 704 perform pre-roam phases. At step 720, STA 702 transmits a roam request to AP 704, resulting in an uplink pause 725 for STA 702 until STA 702 receives a roam response from AP 704 at step 730.

Although FIG. 7 illustrates one example of an uplink pause 700, various changes may be made to FIG. 7. For example, various changes to pre-roam phases could be made, etc. according to particular needs.

Various embodiments of the present disclosure provide procedures to compensate for an uplink pause.

As noted above, various embodiments of the present disclosure provide solutions for a STA to indicate its unavailability to an AP, as well as for handling unavailability updates such as Co-Ex information updates.

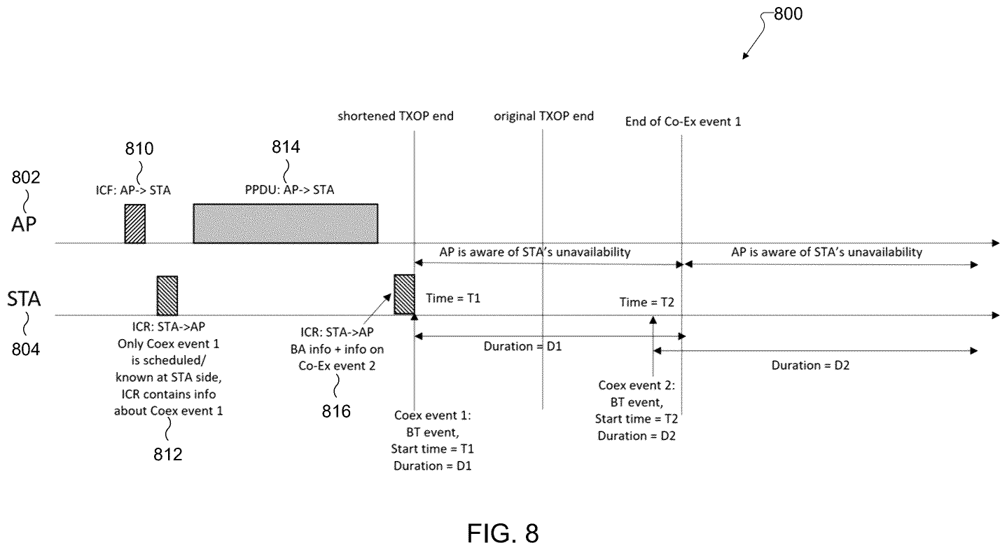

In some embodiments, instead of transmitting a block acknowledgement (BA), the STA can transmit an ICR that contains the information of the BA and the Co-Ex event, similar as shown in FIG. 8.

FIG. 8 illustrates an example of updating Co-Ex/unavailability information at an AP through a modified BA variant 800 according to embodiments of the present disclosure. The embodiment of updating Co-Ex/unavailability information of FIG. 8 is for illustration only. Different embodiments of updating Co-Ex/unavailability information at an AP through a modified BA variant could be used without departing from the scope of this disclosure.

The example of FIG. 8 is described with respect to a Co-Ex event. However, the procedures in the example of FIG. 8 can be applied for any type of unavailability event. In the example of FIG. 8, an AP 802 sends an ICF 810 to a STA 804. At the time of receiving the ICF 810, STA 804 is aware of a Co-Ex event 1 and sends the information of Co-Ex event 1 to the AP 802 in the ICR 812. In response, AP 802 can shorten the TXOP length as per the indicated information to avoid Co-Ex event 1. However, before the end of the TXOP, another Co-Ex event 2 is scheduled at a time T2 and with a duration of D2. After reception of PPDU 814, instead of transmitting a BA in response, STA 804 transmits another ICR 816 that contains the information of the BA and the Co-Ex event 2. Because AP 802 is now aware of the Co-Ex event 2, AP 802 may refrain from transmitting a downlink transmission to STA 804 during duration D2.

Although FIG. 8 illustrates one example of updating Co-Ex/unavailability information at an AP through a modified BA variant 800, various changes may be made to FIG. 8. For example, various changes to times and durations could be made, etc. according to particular needs.

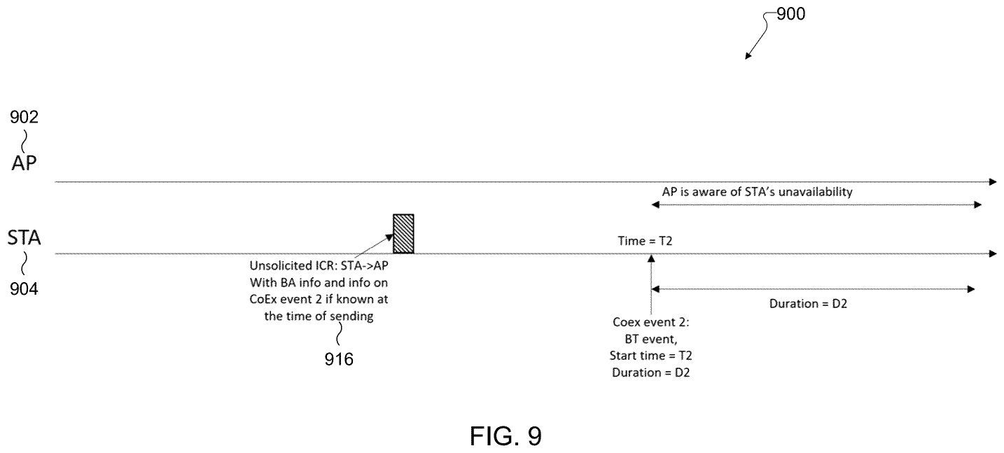

In some embodiments, an unsolicited ICR can be transmitted to the AP by the STA, similar as shown in FIG. 9.

FIG. 9 illustrates an example of sending an unsolicited ICR 900 according to embodiments of the present disclosure. The embodiment of sending an unsolicited ICR of FIG. 9 is for illustration only. Different embodiments of sending an unsolicited ICR could be used without departing from the scope of this disclosure.

The example of FIG. 9 is described with respect to a Co-Ex event. However, the procedures in the example of FIG. 9 can be applied for any type of unavailability event. In the example of FIG. 9, a STA 904 becomes aware of a Co-Ex event 2 scheduled at a time T2 and with a duration of D2. STA 904 transmits an unsolicited ICR 916 to an AP 902 that contains the information of the BA and the Co-Ex event 2. Because AP 902 is now aware of the Co-Ex event 2, AP 902 may refrain from transmitting a downlink transmission to STA 904 during duration D2.

Although FIG. 9 illustrates one example of sending an unsolicited ICR 900, various changes may be made to FIG. 9. For example, various changes to times and durations could be made, etc. according to particular needs.

In some embodiments, when a STA has setup a BA session, if the STA also enters into a Co-Ex mode, the STA can start to send an ICR instead of the BA. In embodiments such as these, an AP that receives an ICR instead of a BA can process the ICR to extract the BA information as well as the Co-Ex update/information from the STA.

In some embodiments, if an AP already has Co-Ex information of a STA and the AP receives another ICR, the AP can update the Co-Ex information with the update from the STA.

In some embodiments, a STA can report a cumulative Co-Ex event information. For instance, instead of reporting for Co-Ex event 1 and Co-Ex event 2 individually, the STA can report for a cumulative of Co-Ex event 1 and Co-Ex event 2. For instance, in the example of FIG. 8, instead of carrying information of Co-Ex event 2 in the second ICR (816), the STA can carry information of the cumulative unavailability period (e.g., start time=T1 and a duration that is enough to cover up to the end of D2).

In some embodiments, if Co-Ex event 2's start time is after the end of Co-Ex event 1's start time, the AP can avoid overwriting Co-Ex event 1's information.

In some embodiments, an ICR can contain an information item that can indicate if this is an update to an existing Co-Ex schedule or an addition to a list of Co-Ex events recorded by the STA with the AP. For instance, when sending an ICR, the ICR can include a field that can indicate that this information corresponds to a second Co-Ex event. If it is an update, the field can include another value to indicate that it is an update. In some embodiments, the field can include a reason code that indicates the reason for sending the ICR is to update an already reported Co-Ex event.

In some embodiments, the STA can include information for multiple Co-Ex events in the same ICR. For example, the ICR may include an update for an existing Co-Ex event 1, and information for a new Co-Ex event 2. When the AP receives such an ICR, the AP can overwrite the previous information available on the AP's end.

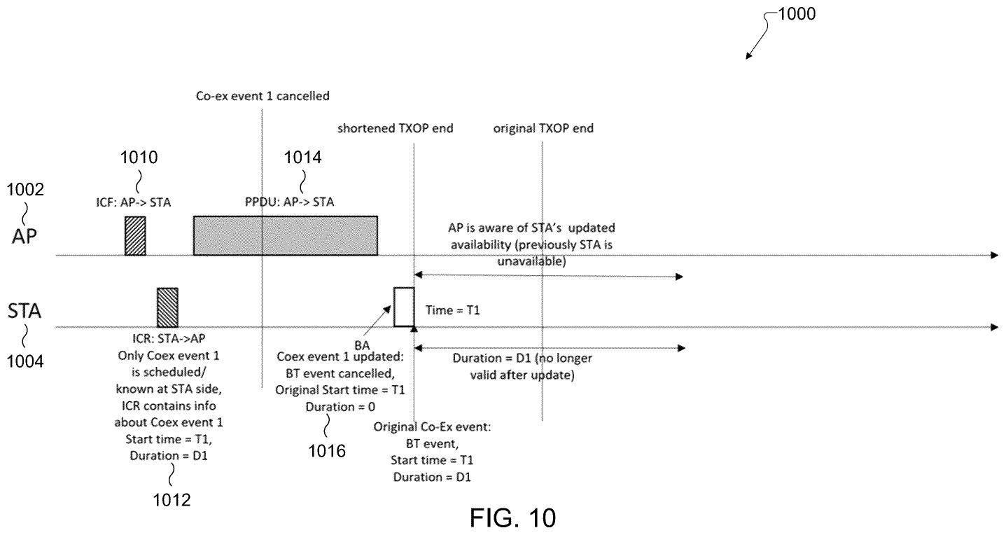

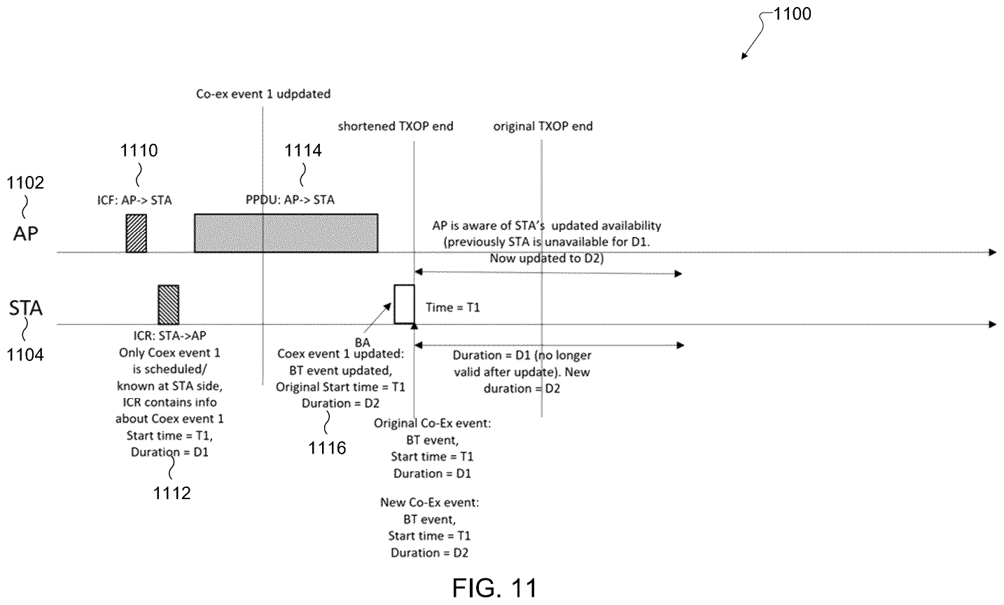

In some embodiments, a STA can update a previously scheduled Co-Ex/unavailability event. For example, the STA can transmit updated scheduling information to the AP in a control frame such as an ICR or BA, similar as shown in FIGS. 10 and 11. In embodiments such as these, there can be an update notification in the control frame. In some embodiments, the control frame may be a buffer status report poll (BSRP) non-trigger based (NTB) trigger frame. In some embodiments, the update notification can comprise at least one or more of the information items as shown in Table 1.

TABLE 1
Cancelation Notification Information Items

| Information items | Description |
|---|---|
| Explicit cancelation | One or more information items that can convey an explicit cancelation |
| notification | notification. For example, a field (such as a bit) that can be set to a |
| | predetermined value to indicate a cancelation and set to another |
| | predetermined value to indicate otherwise. |
| Implicit cancelation | One or more information items that can convey an implicit |
| notification | cancelation notification. For example, setting the duration value for |
| | the Co-Ex/unavailability event reported in the ICR to zero as shown in |
| | FIG. 10. This can void any previously provided Co-Ex/unavailability |
| | report. |

In some embodiments, the scheduling information may be a feedback user info field with a feedback type field set to 0 and an unavailability event duration field set to 0 that indicates that the STA intends to transition from unavailable to available.

In some embodiments a start time can serve as a reference as to which Co-Ex/unavailability event the STA refers to when providing an update. For example, if the STA reports information about another Co-Ex/unavailability event with the exact same start time as a previously reported event, then the second report can be treated as an update to the previously provided report. In some embodiments, the start time may not serve as a reference, and any new report may replace the previous one.

FIG. 10 illustrates an example of Co-Ex/unavailability cancelation 1000 according to embodiments of the present disclosure. The embodiment of Co-Ex/unavailability cancelation of FIG. 10 is for illustration only. Different embodiments of Co-Ex/unavailability cancelation could be used without departing from the scope of this disclosure.

The example of FIG. 10 is described with respect to a Co-Ex event. However, the procedures in the example of FIG. 10 can be applied for any type of unavailability event. In the example of FIG. 10, an AP 1002 sends an ICF 1010 to a STA 1004. At the time of receiving the ICF 1010, STA 1004 is aware of a Co-Ex event 1 (for example, with a Bluetooth [BT] radio) and sends the information of Co-Ex event 1 to the AP 1002 in the ICR 1012. In response, AP 1002 can shorten the TXOP length as per the indicated information to avoid Co-Ex event 1. However, before the end of the TXOP, the Co-Ex event 1 is canceled. After reception of PPDU 1014, STA 1004 transmits a BA 1016 that contains updated information for the Co-Ex event 1, where the duration is 0. Because the updated information includes the original start time of T1 and a duration of 0, AP 1002 interprets the update as the Co-Ex event 1 being canceled, and the AP 1002 may schedule any downlink transmissions for STA 1004 accordingly.

Although FIG. 10 illustrates one example of Co-Ex/unavailability cancelation 1000, various changes may be made to FIG. 10. For example, various changes to times and durations could be made, etc. according to particular needs.

FIG. 11 illustrates an example of Co-Ex/unavailability update 1100 according to embodiments of the present disclosure. The embodiment of Co-Ex/unavailability update of FIG. 11 is for illustration only. Different embodiments of Co-Ex/unavailability update could be used without departing from the scope of this disclosure.

The example of FIG. 11 is described with respect to a Co-Ex event. However, the procedures in the example of FIG. 11 can be applied for any type of unavailability event. In the example of FIG. 11, an AP 1102 sends an ICF 1110 to a STA 1104. At the time of receiving the ICF 1110, STA 1104 is aware of a Co-Ex event 1 (for example, with a BT radio) and sends the information of Co-Ex event 1 to the AP 1102 in the ICR 1112. In response, AP 1102 can shorten the TXOP length as per the indicated information to avoid Co-Ex event 1. However, before the end of the TXOP, the Co-Ex event 1 is updated. After reception of PPDU 1114, STA 1104 transmits a BA 1116 that contains updated information for the Co-Ex event 1, where the duration is changed from D1 to D2. Because the updated information includes the original start time of T1 and a duration of D2, AP 1102 interprets the update as the Co-Ex event 1 being changed to the new duration D2, and the AP 1102 may schedule any downlink transmissions for STA 1104 accordingly.

Although FIG. 11 illustrates one example of Co-Ex/unavailability update 1100, various changes may be made to FIG. 11. For example, various changes to times and durations could be made, etc. according to particular needs.

As noted above, various embodiments of the present disclosure provide procedures to compensate for an uplink pause.

In some embodiments, a fast flushing of uplink packets can be performed to compensate for an uplink pause.

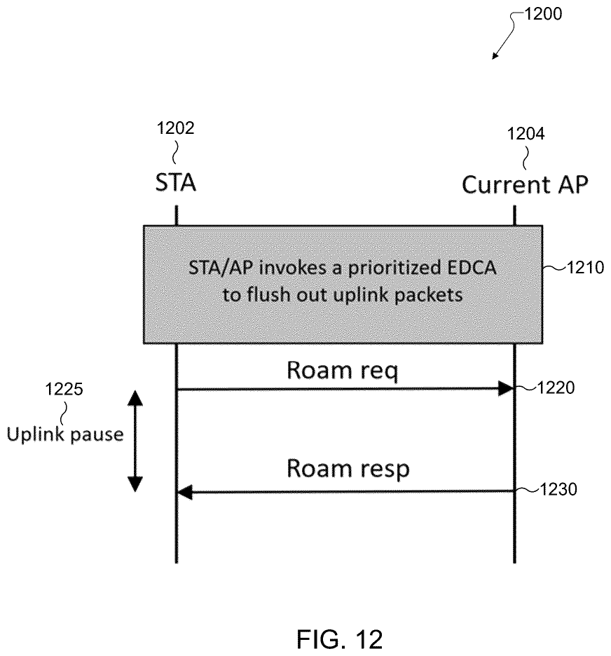

In some embodiments, a priority enhanced distributed channel access (EDCA) (e.g., high priority [Hip]-EDCA, enhanced EDCA, etc.) can be invoked to transmit uplink packets prior to roam, similar as shown in FIG. 12. This can be done in anticipation of an uplink pause during the roaming phase. The priority EDCA can be invoked by the STA or by the AP (with the knowledge that the STA has performed a preparation phase).

FIG. 12 illustrates an example of invoking a prioritized EDCA to flush out uplink packets prior to roam 1200 according to embodiments of the present disclosure. The embodiment of invoking a prioritized EDCA to flush out uplink packets prior to roam of FIG. 12 is for illustration only. Different embodiments of invoking a prioritized EDCA to flush out uplink packets prior to roam could be used without departing from the scope of this disclosure.

In the example of FIG. 12, AP 1204 is a current AP for STA 1202 at step 1210, where one of the STA 1202 and AP 1204 invokes a prioritized EDCA to flush out uplink packets. At step 1220, STA 1202 transmits a roam request to AP 1204, resulting in an uplink pause 1225 for STA 1202 until STA 1202 receives a roam response from AP 1204 at step 1230. Because the uplink packets were flushed during the prioritized EDCA, this compensates for the uplink pause.

Although FIG. 12 illustrates one example of invoking a prioritized EDCA to flush out uplink packets prior to roam 1200, various changes may be made to FIG. 12. For example, various changes to the invocation could be made, etc. according to particular needs.

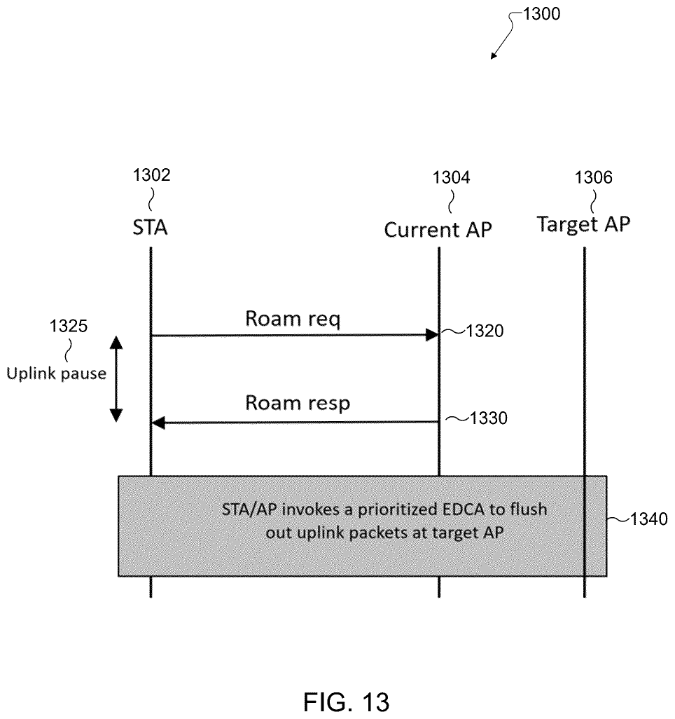

In some embodiments, a priority EDCA can be invoked to transmit uplink packets upon roam, similar as shown in FIG. 13. This can be used for uplink packets that have faced a delay due to the uplink pause during roam.

FIG. 13 illustrates an example of invoking a prioritized EDCA to flush out uplink packets upon roam 1300 according to embodiments of the present disclosure. The embodiment of invoking a prioritized EDCA to flush out uplink packets upon roam of FIG. 13 is for illustration only. Different embodiments of invoking a prioritized EDCA to flush out uplink packets upon roam could be used without departing from the scope of this disclosure.

In the example of FIG. 13, AP 1304 is a current AP for STA 1302 at step 1320, where STA 1302 transmits a roam request to AP 1304 to roam to target AP 1306. This results in an uplink pause 1325 for STA 1302 until STA 1302 receives a roam response from AP 1304 at step 1330. At Step 1340, one of the STA 1302 and AP 1304 invokes a prioritized EDCA to flush out uplink packets at the target AP 1306. Because the uplink packets were flushed during the prioritized EDCA, this helps to compensate for the uplink pause.

Although FIG. 13 illustrates one example of invoking a prioritized EDCA to flush out uplink packets upon roam 1300, various changes may be made to FIG. 13. For example, various changes to the invocation could be made, etc. according to particular needs.

In some embodiments, a STA can make a low latency indication to the STA's current AP in anticipation of an uplink pause. The low latency indication can be made at the start of a TXOP to enable the STA to flush out packets that can face an issue due to the uplink pause. This can indicate to the AP that the STA's packets should be transmitted in the upcoming TXOP or in one or more of the following TXOPs. The AP can then take actions accordingly to prioritize transmission of the uplink packets. In embodiments such as these, the STA can make an indication of when the AP can stop or the STA can continue to make an indication that the AP can continue to take actions (e.g., invoking reverse direction grant [RDG] protocol) to allow for uplink transmission of such packets.

In some embodiments, a STA can share timing information with an AP to indicate to the AP that uplink packets should be transmitted prior to a deadline. This deadline can be the time at which the packets can expire or the time at which the STA anticipates to trigger a roam point. In embodiments such as these, the timing information can be shared with the STA's current AP or with the target AP.

In some embodiments, a STA can request for aggressive AP side triggering at the time of roaming. For example, the request can be made by including a buffer status report (BSR) or any information therein as a part of the roaming preparation phase. In embodiments, such as these, the STA can also indicate an anticipated data backlog or request for the AP to fetch BSRs more frequently until roam. Thus, the AP can infer the backlog more accurately and trigger the STA to fetch the uplink packets.

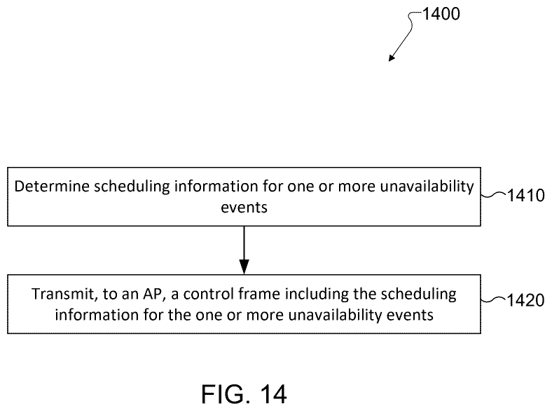

FIG. 14 illustrates an example method for unavailability event handling 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for unavailability event handling could be used without departing from the scope of this disclosure.

In the example of FIG. 14, method 1400 begins at step 1410. At step 1410, a STA (such as STA 804, 904, 1004, or 1104) determines scheduling information for one or more unavailability events. For example, in some embodiments, the STA may determine scheduling information for one or more Co-Ex events.

At step 1420, the STA transmits, to an AP (such as AP 802, 902, 1002, or 1102), a control frame including the scheduling information for the one or more unavailability events.

In some embodiments, the control frame may be at least one of an unsolicited control frame and a substitute for a BA frame. In some embodiments, the one or more unavailability events may include one or more Co-Ex events. In some embodiments, the scheduling information for the one or more unavailability events may be cumulative information of a plurality of unavailability events.

In some embodiments, the scheduling information may include at least one of an unavailability event identifier, an unavailability event start time, and an unavailability event duration. In some embodiments, the scheduling information may include an unavailability event start time that serves as an unavailability event identifier.

In some embodiments, the scheduling information may include at least one of an indication that the scheduling information includes an updated schedule for an unavailability event previously provided to the AP, and an indication that the scheduling information includes a schedule for an unavailability event that has not been previously provided to the AP.

In some embodiments, the scheduling information may include an indication that the scheduling information includes an updated schedule for an unavailability event previously provided to the AP. In embodiments such as these, the indication may be as least one of an unavailability event start time previously provided to the AP, and a reason code field in the control frame indicating that the control frame is for updating the unavailability event previously provided to the AP.

In some embodiments, the control frame may be a buffer status report poll (BSRP) non-trigger based (NTB) trigger frame. In embodiments such as these, the scheduling information may be a feedback user info field with a feedback type field set to 0 and an unavailability event duration field set to 0 that indicates that the STA intends to transition from unavailable to available.

In some embodiments, the scheduling information may include an indication of cancelation of unavailability information associated with a corresponding unavailability event previously provided to the AP.

Although FIG. 14 illustrates one example method for unavailability event handling 1400, various changes may be made to FIG. 14. For example, while shown as a series of steps, various steps in FIG. 14 could overlap, occur in parallel, occur in a different order, occur any number of times, be omitted, or replaced by other steps.

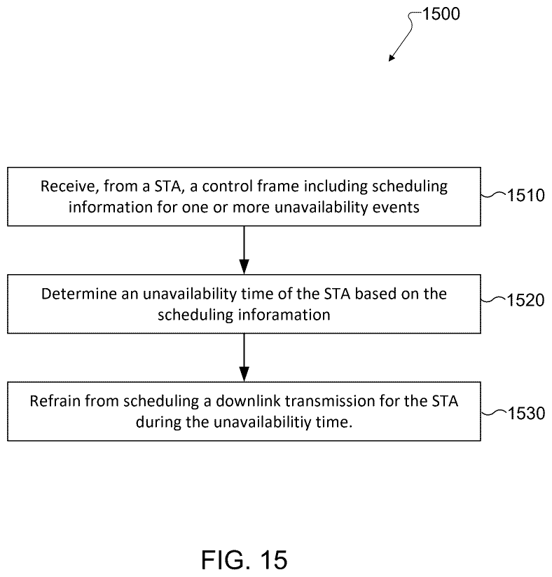

FIG. 15 illustrates another example method for unavailability event handling 1500 according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for unavailability event handling could be used without departing from the scope of this disclosure.

In the example of FIG. 15, method 1500 begins at step 1510. At step 1510, an AP (such as AP 802, 902, 1002, or 1102) receives, from a STA (such as STA 804, 904, 1004, or 1104), a control frame including scheduling information for one or more unavailability events.

At step 1520, the AP determines an unavailability time of the STA based on the scheduling information.

At step 1530, the AP refrains from scheduling a downlink transmission for the STA during the unavailability time.

In some embodiments, the control frame may be at least one of an unsolicited control frame and a substitute for a BA frame. In some embodiments, the one or more unavailability events may include one or more Co-Ex events. In some embodiments, the scheduling information for the one or more unavailability events may be cumulative information of a plurality of unavailability events.

In some embodiments, the scheduling information may include at least one of an unavailability event identifier, an unavailability event start time, and an unavailability event duration. In some embodiments, the scheduling information may include an unavailability event start time that serves as an unavailability event identifier.

In some embodiments, the scheduling information may include at least one of an indication that the scheduling information includes an updated schedule for an unavailability event previously provided to the AP, and an indication that the scheduling information includes a schedule for an unavailability event that has not been previously provided to the AP.

In some embodiments, the scheduling information may include an indication that the scheduling information includes an updated schedule for an unavailability event previously provided to the AP. In embodiments such as these, the indication may be as least one of an unavailability event start time previously provided to the AP, and a reason code field in the control frame indicating that the control frame is for updating the unavailability event previously provided to the AP.

In some embodiments, the control frame may be a buffer status report poll (BSRP) non-trigger based (NTB) trigger frame. In embodiments such as these, the scheduling information may be a feedback user info field with a feedback type field set to 0 and an unavailability event duration field set to 0 that indicates that the STA intends to transition from unavailable to available.

In some embodiments, the scheduling information may include an indication of cancelation of unavailability information associated with a corresponding unavailability event previously provided to the AP.

Although FIG. 15 illustrates one example method for unavailability event handling 1500, various changes may be made to FIG. 15. For example, while shown as a series of steps, various steps in FIG. 15 could overlap, occur in parallel, occur in a different order, occur any number of times, be omitted, or replaced by other steps.

While various embodiments of the present disclosure are described with respect to one or more Co-Ex events, it should be understood that these embodiments are not limited to Co-Ex, and any of the embodiments may be used for any kind of unavailability. For example, the embodiments described herein may be used for power save (PS) related unavailability. Furthermore, any of the embodiments described herein may be applied to both single link and multi-link operation.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A station (STA) comprising:
a processor configured to determine scheduling information for one or more unavailability events; and
a transceiver operably coupled to the processor, the transceiver configured to transmit, to an access point (AP), a control frame including the scheduling information for the one or more unavailability events.

2. The STA of claim 1, wherein the control frame is at least one of an unsolicited control frame and a substitute for a block acknowledgement (BA) frame.

3. The STA of claim 1, wherein the one or more unavailability events include one or more coexistence (Co-Ex) events.

4. The STA of claim 1, wherein the scheduling information for the one or more unavailability events is cumulative information of a plurality of unavailability events.

5. The STA of claim 1, wherein the scheduling information includes at least one of:
an unavailability event identifier;
an unavailability event start time; and
an unavailability event duration.

6. The STA of claim 1, wherein the scheduling information includes at least one of:
an indication that the scheduling information includes an updated schedule for an unavailability event previously provided to the AP; and
an indication that the scheduling information includes a schedule for an unavailability event that has not been previously provided to the AP.

7. The STA of claim 1, wherein:
the scheduling information includes an indication that the scheduling information includes an updated schedule for an unavailability event previously provided to the AP; and
the indication is at least one of:
an unavailability event start time previously provided to the AP; and
a reason code field in the control frame indicating that the control frame is for updating the unavailability event previously provided to the AP.

8. The STA of claim 1, wherein the scheduling information includes an unavailability event start time that serves as an unavailability event identifier.

9. The STA of claim 1, wherein:
the control frame is a buffer status report poll (BSRP) non-trigger based (NTB) trigger frame; and
the scheduling information is a feedback user info field with a feedback type field set to 0 and an unavailability event duration field set to 0 that indicates that the STA intends to transition from unavailable to available.

10. The STA of claim 1, wherein the scheduling information includes an indication of cancelation of unavailability information associated with a corresponding unavailability event previously provided to the AP.

11. An access point (AP) comprising:
a transceiver configured to receive, from a station (STA), a control frame including scheduling information for one or more unavailability events; and
a processor operably coupled to the transceiver, the processor configured to:
determine an unavailability time of the STA based on the scheduling information; and
refrain from scheduling a downlink transmission for the STA during the unavailability time.

12. The AP of claim 11, wherein the control frame is at least one of an unsolicited control frame and a substitute for a block acknowledgement (BA) frame.

13. The AP of claim 11, wherein the one or more unavailability events include one or more coexistence (Co-Ex) events.

14. The AP of claim 11, wherein the scheduling information for the one or more unavailability events is cumulative information of a plurality of unavailability events.

15. The AP of claim 11, wherein the scheduling information includes at least one of:
an unavailability event identifier;
an unavailability event start time; and
an unavailability event duration.

16. The AP of claim 11, wherein the scheduling information includes at least one of:
an indication that the scheduling information includes an updated schedule for an unavailability event previously provided to the AP; and
an indication that the scheduling information includes a schedule for an unavailability event that has not been previously provided to the AP.

17. The AP of claim 11, wherein:
the scheduling information includes an indication that the scheduling information includes an updated schedule for an unavailability event previously provided to the AP; and
the indication is at least one of:
an unavailability event start time previously provided to the AP; and
a reason code field in the control frame indicating that the control frame is for updating the unavailability event previously provided to the AP.

18. The AP of claim 11, wherein the scheduling information includes an unavailability event start time that serves as an unavailability event identifier.

19. The AP of claim 11, wherein:
the control frame is a buffer status report poll (BSRP) non-trigger based (NTB) trigger frame; and
the scheduling information is a feedback user info field with a feedback type field set to 0 and an unavailability event duration field set to 0 that indicates that the STA intends to transition from unavailable to available.

20. The AP of claim 11, wherein the scheduling information includes an indication of cancelation of unavailability information associated with a corresponding unavailability event previously provided to the AP.
